(19) United States
(12) Patent Application Publication
(10) Pub. No.: US 2014/0090519 A1
(43) Pub. Date: Apr. 3, 2014

(54) OPEN-ENDED WRENCH HAVING MOVABLE ARMS

(71) Applicant: Robert Kundel, JR., Cortland, OH (US)

(72) Inventor: Robert Kundel, JR., Cortland, OH (US)

(21) Appl. No.: 14/038,361

(22) Filed: Sep. 26, 2013

Related U.S. Application Data
(60) Provisional application No. 61/708,639, filed on Oct. 2, 2012.

(51) Int. Cl. B25B 13/48; B25B 13/58; B25B 23/16; B25B 13/08

(52) U.S. Cl. CPC B25B 13/481; B25B 13/08; B25B 13/58; B25B 23/16
USPC 81/119; 81/177.7; 81/177.2

(57) ABSTRACT

This invention relates to an open-ended wrench device, consisting of two pivoting arms diametrically opposed on either side of the open-ended wrench. The open-ended wrench device of the claimed invention can be used in plumbing situations in small, enclosed or obstructed spaces. Specifically, the device can be fitted over a fixture, such as a nut underneath a sink with the pivoting arms in the down position. In order to tighten or loosen the fixture in the enclosed space, the pivoting arms can be raised as much as the space permits in order to allow a user to apply the necessary toque to the wrench. The invention further consists of interchangeable plates which can be removably inserted into a slot of the wrench opening to accommodate fixtures of various sizes and shapes.

### FILED OF THE INVENTION

This invention relates to an open-ended wrench having movable arms to be used in small, enclosed or obstructed spaces, such as in plumbing applications. This invention further relates to an open-ended wrench having movable arms and interchangeable plates which can be removably inserted into the wrench opening to accommodate fixtures of various sizes and shapes.

### BACKGROUND OF THE INVENTION

Wrenches are typically used to turn a bolt head or nut. There are a variety of different types of wrenches appropriate for different applications and situations, such as the accessibility of the element to be turned. For example, when trying to loosen or tighten a shower drain in a typical plumbing layout, there are constraints to the work environment that do not allow use of large tools. Currently, in order to reach and tighten a nut located under a shower drain, large jaw pliers or even a screwdriver and a hammer are typically used.

A need exists in many different industries to provide a wrench that is able to be used in tight and/or enclosed spaces that is easy to use, can fit a variety of fixtures, as well as economical to produce and transport.

### BRIEF SUMMARY OF THE INVENTION

The claimed invention consists of an open-ended wrench device having two movable arms pivotably attached thereto. The open-ended wrench has a substantially “U” or “C” shape to accommodate a hexagonal nut. The movable arms are attached to the open-ended wrench at either side of the wrench opening and are parallel to each other. The movable arms are able to flex upwards or downwards when pressure is applied by a user. The arms can be attached to the open-ended wrench by hinged or ball and socket connection. Thereby, the device can be fitted around a fixture, such as a sealing ring, hexagonal nut or locknut, allowing a user to either tighten or loosen the nut by gripping each arm and pivoting to fit in the space as necessary.

The claimed invention further consists of interchangeable plates which can be removably inserted into a slot of the wrench opening to accommodate various sized and shaped fixtures. Said plates enable the device to securely fit around any size, shape or type of fixture while not requiring a user to acquire an entirely new wrench device to fit each particular job.

A specific use of the claimed device would be for use in installing a shower drain, which is typically located between floor joist connections that are spaced 16″ apart. During installation, a shower drain must be tightened to form a watertight seal. To accomplish this, a sealant, such as plumber's putty, is applied to the rim of the shower drain. Next, the drain is installed in the opening located at the bottom of the shower stall. A sealing ring or a hexagonal shaped nut, typically formed of plastic, is then threaded onto the drain base and tightened against the bottom of the shower to form a watertight seal.

The sealing ring or nut is typically six sided to enable the wrench to grip the surface while it is being loosened or tightened. This is typically accomplished by use of large jaw pliers, or even a screwdriver and a hammer, due to the limited space between the shower stall and the wooden frame at the base of the shower. The limited and often obstructed access to the sealing nut can make it difficult to properly tighten the nut to the base of the drain, which can result in an improper seal and later water damage.

In view of the aforementioned and other environmental constraints in plumbing applications that does not allow the use of large tools, there is a need for a wrench device that is compact in design yet allows a user to generate the necessary torque to tighten or loosen a nut. The maneuverability and versatility of the subject device makes it ideal for use in tightly enclosed spaces.

The scope of applicability of the preferred embodiment will become apparent from the following detailed description, claims and drawings. It should be understood that the description and specific examples, although indicating preferred embodiments of the invention, are given by way of illustration only. Various changes and modifications to the described embodiments and examples will be apparent to those skilled in the art.

### BRIEF DESCRIPTION OF THE DRAWINGS

Having generally described the nature of the invention, reference will now be made to the accompanying drawings used to illustrate and describe the preferred embodiments thereof. Further, these and other advantages will become apparent to those skilled in the art from the following detailed description of the embodiments when considered in light of these drawings in which:

FIG. 1A-1C show perspective views of the device in various open and closed positions.

FIG. 2A shows an exploded view of a drain and FIG. 2B shows a perspective view of a complete drain.

FIG. 3A-3B a show exploded views of the entire device.

FIG. 4A shows a perspective view of the device and a drain fixture, and

FIG. 4B show a perspective view of the device fitted over said drain fixture.

FIG. 5 shows a side plan view of the device fitted around a drain fixture located between floor joists.

### DETAILED DESCRIPTION OF THE INVENTION

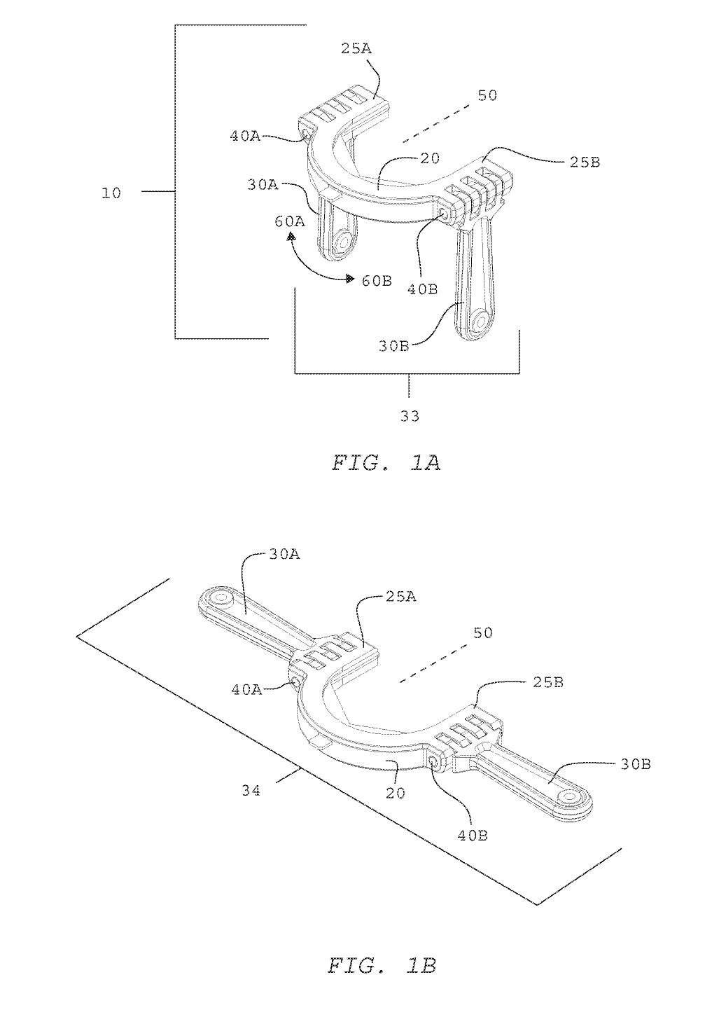

FIG. 1A-1C refers to the entire open-ended wrench device (10), which can be fabricated out of steel, aluminum and/or plastic. Although in the preferred embodiment, the device would be produced out of steel or plastic to enable cost-effective fabrication and transport, any structural material may be used for the purpose of this invention.

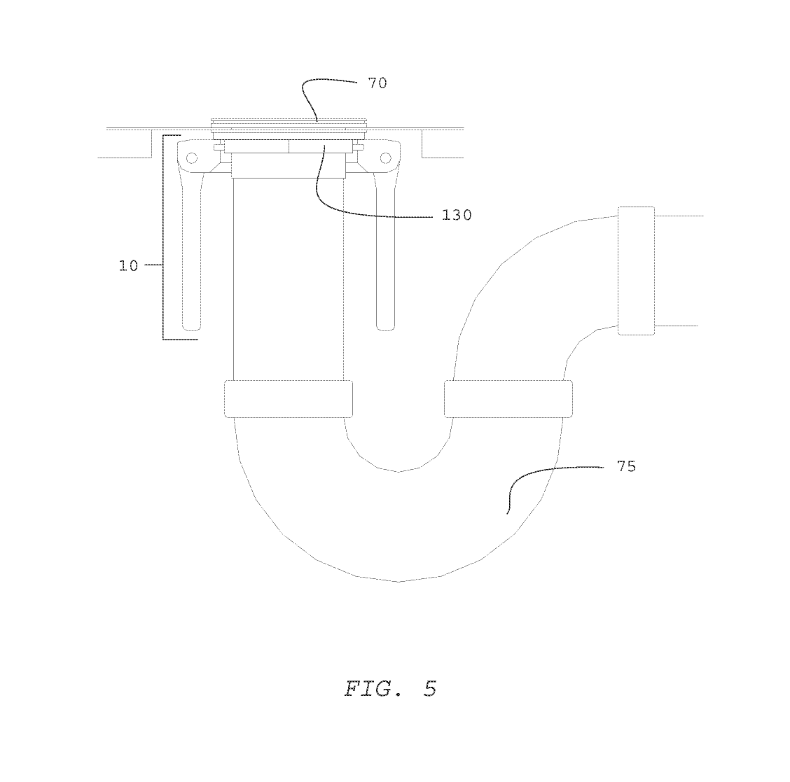

The open-ended wrench device (10) generally includes an open-ended wrench (20) having a wrench opening (50) to accommodate a fixture (130), such as a sealing ring, locknut or a hexagonal nut. However, for the purposes of this invention, the generic term fixture will be used to describe the member (130) to be tightened or loosened. Affixed to two parallel arms (25A, 25B), located on the ventral end of the open-ended wrench (20), are pivoting wing members (30A, 30B). The wing members (30A, 30B) are attached to the parallel arms (25A, 25B) by means of hinges (40A, 40B). When a user grasps the device (10) by the wing members (30A, 30B) and applies pressure in an upward or downward motion, the wing members (30A, 30B) pivot (60A, 60B) accordingly on the hinges (40A, 40B). This pivoting motion (60A, 60B) of the wing members (30A, 30B) enables the user to properly align the device in small or obstructed spaces, and still generate the necessary torque or pressure to tighten or loosen the fixture (130), as shown in FIG. 5.

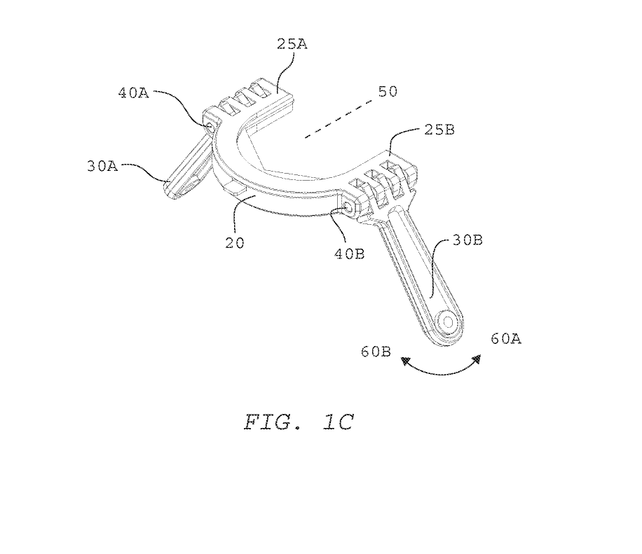

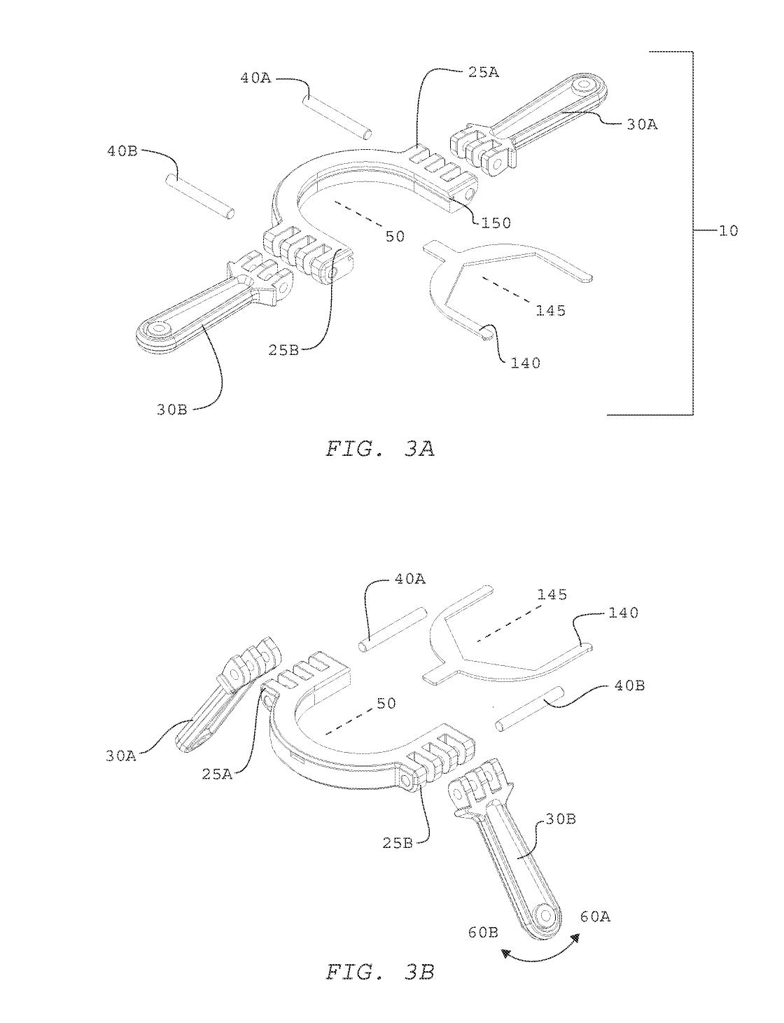

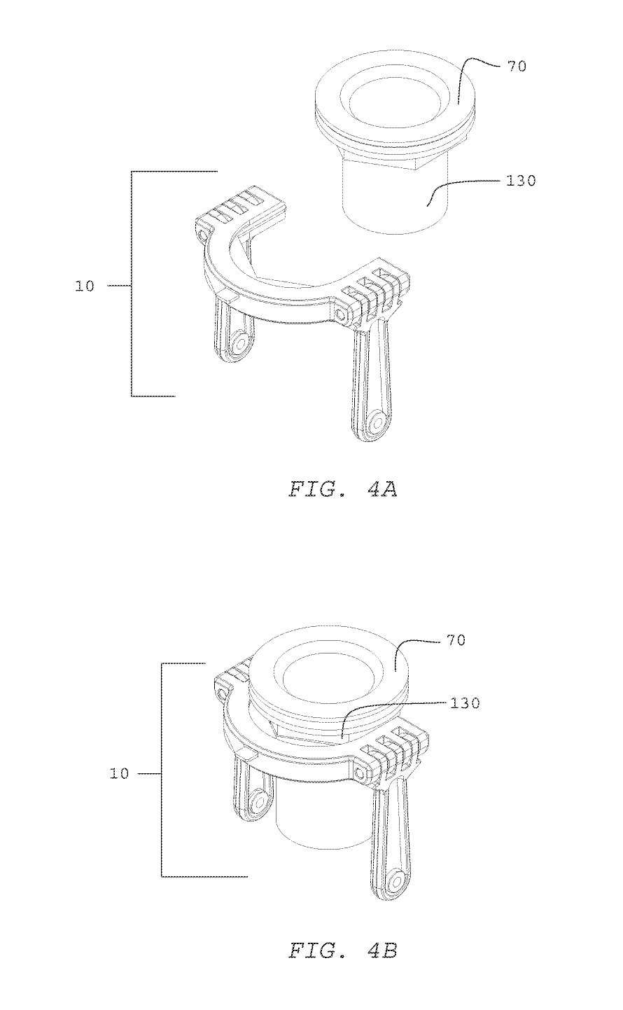

For example, the claimed device (10) could be used when installing a shower drain (70). As shown in FIGS. 2A and 2B, a shower drain (70) typically includes a rubber gasket (110), a fiber gasket (120) and a fixture (130). Once the shower drain (70) components are assembled by a user, the fixture (130) must be tightened in order to create a watertight seal. As the drain is generally located between floor joist connections that are spaced 16″ on a center line apart, there is limited space and often obstructions when inserting a tool to tighten the fixture (130). However, the claimed device (10) can be maneuvered into the tight space by grasping each wing (30A, 30B) in the closed position (33), inserting the wrench opening (50) around the fixture (130), raising each wing (30A, 30B) to an open position (34) allowed by the space and applying the necessary pressure to tighten the fixture (130), as shown in FIGS. 4A-4B and 5. See FIGS. 1A-1C for photographs of the device in various open and closed positions.

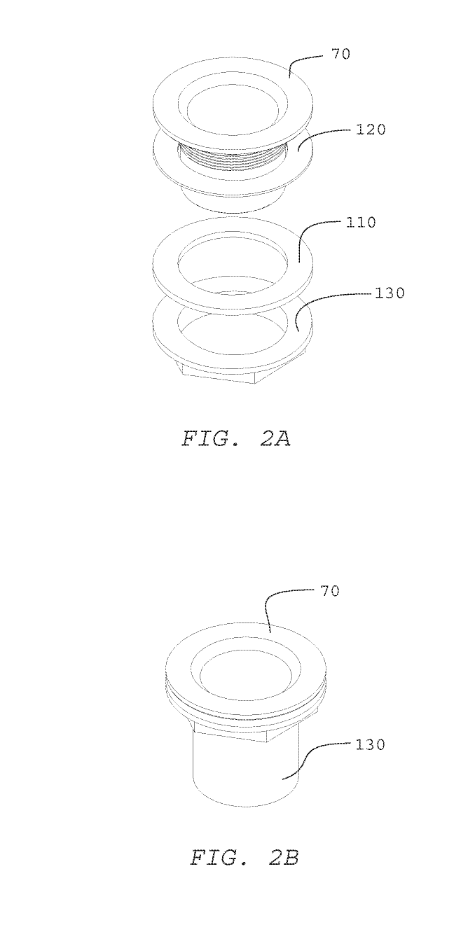

In order to accommodate a variety of different or odd sized fixtures (130), various plates (140) can be inserted into a slot (150) located in the wrench opening (50) of the claimed device (10). Specifically, a plate (140) can be inserted or removed from the slot (150) in the wrench opening (50), as shown in FIGS. 3A-3B. Said plates (140) can have openings (145) of various shapes, such as triangular, square, hexagonal, octagonal, circular, rectangular or oval to accommodate any fixture (130). Although triangular, square, hexagonal, octagonal, circular, rectangular and oval shapes have been described above for the the plate opening (145), the opening (145) can be fabricated to accommodate any shaped fixture and is not limited to the shapes or dimensions described or depicted herein. However, insertion of a plate (140) into the wrench opening (50) of the device (10) is not required to securely accommodate a fixture (130).

Another embodiment of the present invention would be the fabrication of a open-ended wrench device (10), consisting of the aforementioned open-ended wrench (20) having a wrench opening (50) to accommodate a fixture (130), such as a sealing ring, locknut or a hexagonal nut, and two parallel arms (25A, 25B) located on the ventral end of the open-ended wrench (20). Extending perpendicular from the two parallel arms (25A, 25B) are two telescoping wings. A user can than grasp the device (10) by the telescoping wing members and apply pressure in an inward or outward motion to extend or retract the wings. The telescoping motion of the wing members enables the user to maneuver the device in small or obstructed spaces and still generate the necessary torque or pressure to tighten or loosen the fixture (130).

It should be noted that the present invention could be practiced otherwise than as specifically illustrated and described, without departing from the spirit or scope of the invention. It is intended that all such modification and alterations be included insofar as they are consistent with the objectives and spirit of the invention.

What is claimed is:

1. An open-ended wrench device consisting of a pair of pivotable arms diametrically attached to the open end of the wrench.

2. The device of claim 1, wherein the pivotable arms are connected to the device by hinges.

3. The device of claim 1, wherein the pivotable arms can be raised or lowered.

4. The device of claim 1, wherein the open-ended wrench can accommodate different sized fixtures.

5. The device of claim 1, wherein the device can be manufactured out of steel, aluminum or plastic.

6. The device of claim 1, wherein a plate can be inserted into a slot in the wrench opening.

7. The plate of claim 6, wherein the plate has an opening to accommodate a fixture of a specific size and shape.

8. The plate of claim 6, wherein the plate is removable and can be interchanged with different plates to accommodate a variety of fixtures.

9. The plate of claim 6, wherein the plate can be manufactured out of steel, aluminum or plastic.

10. An open-ended wrench device consisting of a pair of telescoping arms diametrically attached to the open end of the wrench.

11. The device of claim 10, wherein the telescoping arms can be depressed or extended.

12. The device of claim 10, wherein the telescoping arms can be extended or retracted.

13. The device of claim 10, wherein the open-ended wrench can accommodate different sized fixtures.

14. The device of claim 10, wherein the device can be manufactured out of steel, aluminum or plastic.

15. The device of claim 10, wherein a plate can be inserted into a slot in the wrench opening.

16. The plate of claim 14, wherein the plate has an opening to accommodate a fixture of a specific size and shape.

17. The plate of claim 14, wherein the plate is removable and can be interchanged with different plates to accommodate a variety of fixtures.

18. The plate of claim 14, wherein the plate can be manufactured out of steel, aluminum or plastic.
